(19) United States
(12) Patent Application Publication
(10) Pub. No.: US 2008/0155431 A1
(43) Pub. Date: Jun. 26, 2008

(54) USER INTERFACE SUPPORTING PROCESSES WITH ALTERNATIVE PATHS

(75) Inventor: Jens BOMBOLOWSKY, Schwetzungen (DE)

Correspondence Address: KENYON & KENYON LLP, 1500 K STREET N.W., SUITE 700, WASHINGTON, DC, 20005, US

(73) Assignee: SAP AG, Walldorf (DE)

(21) Appl. No.: 11/613,650

(22) Filed: Dec. 20, 2006

(51) Int. Cl. G06F 3/048

(52) U.S. Cl. 715/762

(57) ABSTRACT

A user interface dynamically builds the interface screen functionality from, among other things, a hierarchical definition of a process. The hierarchical definition may identify several process steps as alternatives for each other. During operation, to build a user interface screen, the user interface displays the content of all process steps within the hierarchy that must be present for the application. The user interface also displays a control—a button, pull down menu or other selector—that when activated permits the user to select which alternative of a process step will be used in the current application. Thereafter, the user interface is modified to display content of both the required process steps and the selected alternatives for the current application.

### BACKGROUND

Modern businesses use computers to perform many business and business related functions including processes such as manufacturing operations, document processing, human resource management, work flow allocation processes, management reports, financial processes, customer contact, etc. Processes typically are defined as a function requiring an ordered sequence of steps and each step may have sub-steps. Within an enterprise management system, a process may be modeled by a business object. Oftentimes, there may be several permissible ways to perform a given process. That is, certain steps may replace other steps within a process and the process remains valid.

It is often difficult to represent processes that possess alternative process steps in a clear manner in existing software systems. The ‘canvas’ (viewable area) of a user interface screen has a limited area. Operators often disfavor user interfaces that are densely-packed with information, particularly when a sizable portion of the displayed information is not relevant to the operator's needs. For example, if a user interface screen simultaneously displayed all steps of a given process, including the alternatives that are not to be used, the user interface screen would be considered cluttered. Accordingly, there is a need in the art for a user interface screen which permits direct navigation to and selection of the desired process steps from among a plurality of steps that are alternatives to each other and simultaneously conserve canvas area.

### BRIEF DESCRIPTION OF THE DRAWINGS

FIG. 1 is a high level block diagram of a software system in which the invention can be used.

FIG. 2 schematically illustrates a process for which the present invention may be used.

FIG. 3 illustrates a process object suitable for use with the present invention.

FIG. 4 illustrates a method according to an embodiment of the present invention.

FIGS. 5 and 6 illustrate user interface screens according to embodiments of the present invention.

### DETAILED DESCRIPTION

The invention relates to a user interface that dynamically builds the interface screen functionality from, among other things, a hierarchical definition of a process. The hierarchical definition may identify several process steps as alternatives for each other. During operation, to build a user interface screen, the user interface displays the content of all process steps within the hierarchy that must be present for the application. The user interface also displays a control—a button, pull down menu or other selector—that when activated permits the user to select which alternative of a process step will be used in the current application. Thereafter, the user interface is modified to display content of both the required process steps and the selected alternatives for the current application.

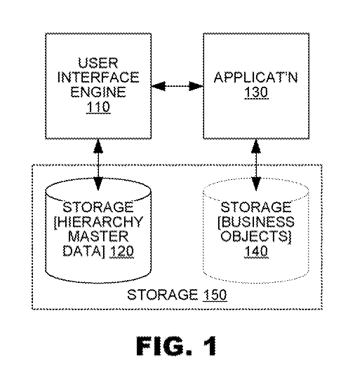

FIG. 1 is a high level block diagram of a software system 100 in which the invention can be used. The system may include a user interface engine 110 (sometimes called a “front end”), one or more back end applications 120 and storage 130, 140 for master data objects and for business objects. The user interface engine 110 that manages interaction with an operator by dynamically generating and delivering user interface screens (typically, HTML pages) to a user's terminal device (not shown). The backend applications support various services offered by the software system 100, which may cause creation and or manipulation of business objects 140. The master data objects 120 and business objects 140 need not be stored in separate storage systems; it is permissible for the objects to be stored in separate systems or a unified storage system (shown as 150) so long as they are addressable by their respective applications 110, 130.

Typically, the user interface engine 110 is a generic program component that can support interaction with several business applications. The user interface engine 110, therefore, does not contain coding that tailors user interfaces for the services offered by the backend application. Instead, the user interface engine 110 dynamically discovers functionality provided by the backend applications 130 and builds user interface screens to accommodate them. The user interface engine 110 reviews master data objects 120 representing business objects from the backend applications 130. The master data objects 120 are hierarchical data files that identify services that are offered in connection with stored business objects 140 and define processes of user interaction with those services. In this regard, the structure and operation of such software systems 100 is well known.

Embodiments of the present invention provide a mechanism through which a user interface engine 100 can identify entities in a master data object that represent alternatives of each other and dynamically generates navigation controls to select and interact with the alternatives. For example, where a business object models a manufacturing process, the master data may identify individual process steps as being optional alternatives for each other; A manufacturing operation may require one of the process steps to be performed to complete the manufacturing operation in question but the operator has discretion to select which alternate should be used while performing the operation. Similarly, where a business object models a banking process (say, a loan approval), one or more process steps may be alternatives for each other that are valid to complete the approval process.

During operation, the user interface engine reviews hierarchy definitions within master data, located in storage 120. The backend application 130 represents business applications that may execute during operation of an enterprise's management system. Common business applications include production management, human resources, product data structure. There are also other hierarchies with the potential need for alternatives. Business records when generated, are stored in business objects within a storage system 140. The storage systems 120 and 140 need not be separate systems. In practice, they may be members of an integrated system (represented by box 150).

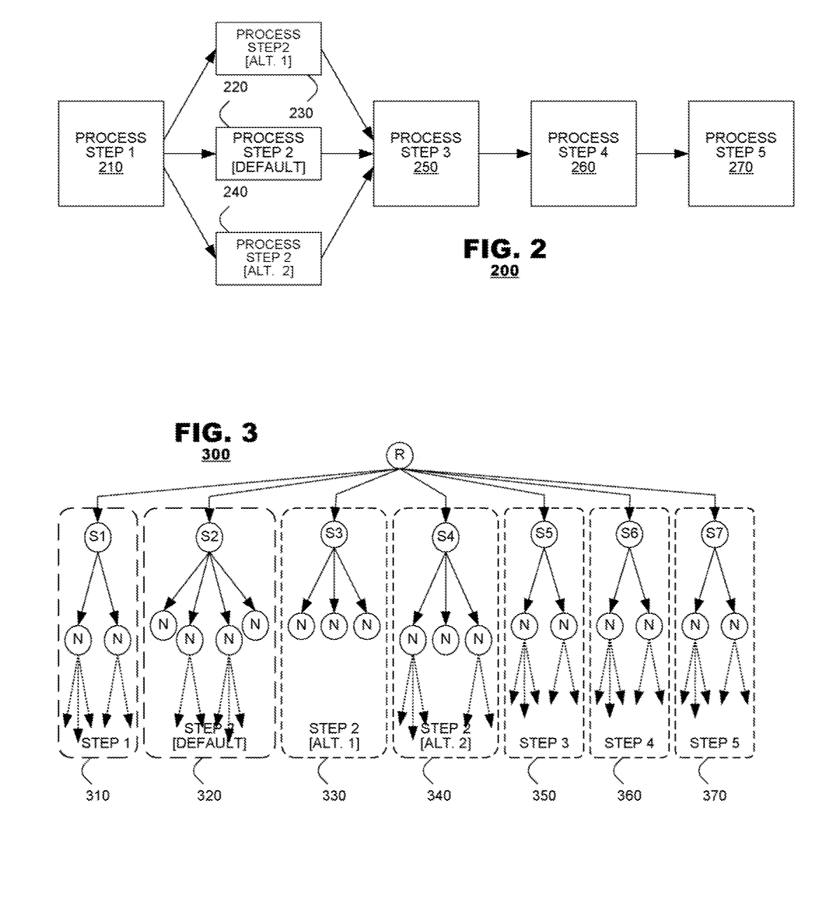

FIG. 2 illustrates an exemplary process that may be modeled by the system of FIG. 1 according to an embodiment of the present invention. In the model illustrated in FIG. 2, a process may be composed of a plurality of process steps 210-270. Step 2, as illustrated, may be performed in one of three ways. Thus, FIG. 2 illustrates a default step 220 and two alternate steps 230, 240.

FIG. 3 illustrates, according to an embodiment of the present invention, an example of an object that might be stored by the system of FIG. 1 to model the process of FIG. 2. For convenience, the object is called a “process object” herein. The process object may be a hierarchical data structure in which process steps may be defined by object nodes and relationships among the nodes define hierarchical relationships among the process steps. In the example of FIG. 3, the process steps 210-270 are illustrated as respective nodes S1-S7, which have equivalent rank within the object hierarchy 300. Process steps that are alternatives of other process steps (e.g., steps 220-240 in FIG. 3) also may have equivalent rank. Process steps may include sub-steps, shown as nodes N (which might include sub-steps of their own, shown with arrows). In this example, all process steps are shown as depending from a common root node.

Each node may include metadata that identifies the corresponding process step as being either a mandatory step or an alternative step. For alternative steps, the metadata may identify which of the alternative steps is the step to be used as default.

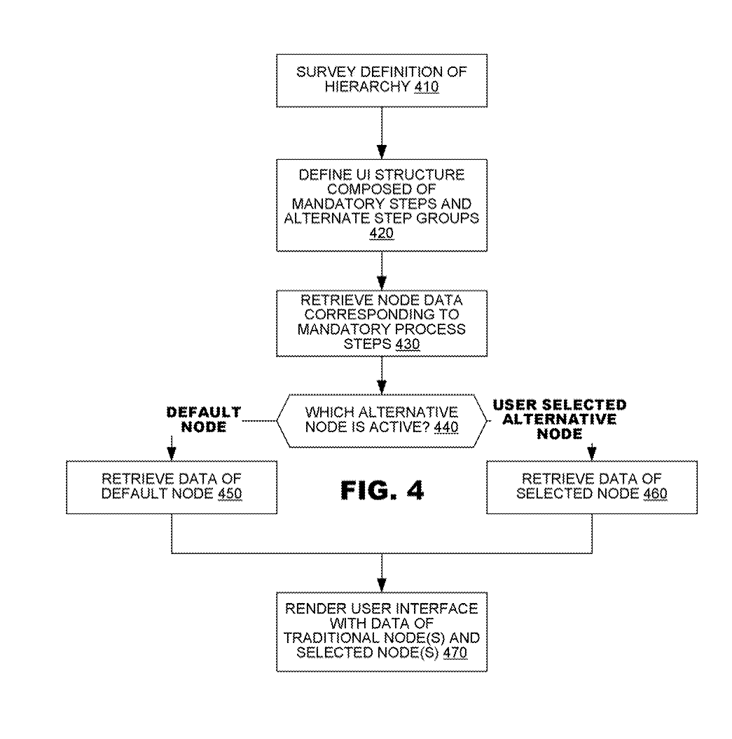

FIG. 4 illustrates a method 400, according to an embodiment of the present invention, that may be used to generate user interfaces to support alternative process steps. The method may begin when the user interface accesses the process object and reviews the node hierarchy (box 410) to identify nodes that correspond to mandatory process steps and to alternate process steps. The method 400 may build a user interface having allocations for each of the mandatory process steps and each of the groups of alternate process steps (box 420). Using the example of FIGS. 2 and 3, the method would generate a user interface having five such allocations because there are four mandatory process steps 210 and 250-270 and one group of alternate process steps. Thereafter, the method may read data from each of the nodes corresponding to mandatory process steps (box 430). The method also identifies which of the alternate process steps is currently active (box 440). If the default step is active, the method may read data from the object node corresponding to the default process step (box 450). If instead a user has selected an alternate process step for use, the method retrieves object data from the node corresponding to the selected step (box 460). Thereafter, the method renders a user interface using the structure derived from the object hierarchy and using the object data retrieved from the object (box 470).

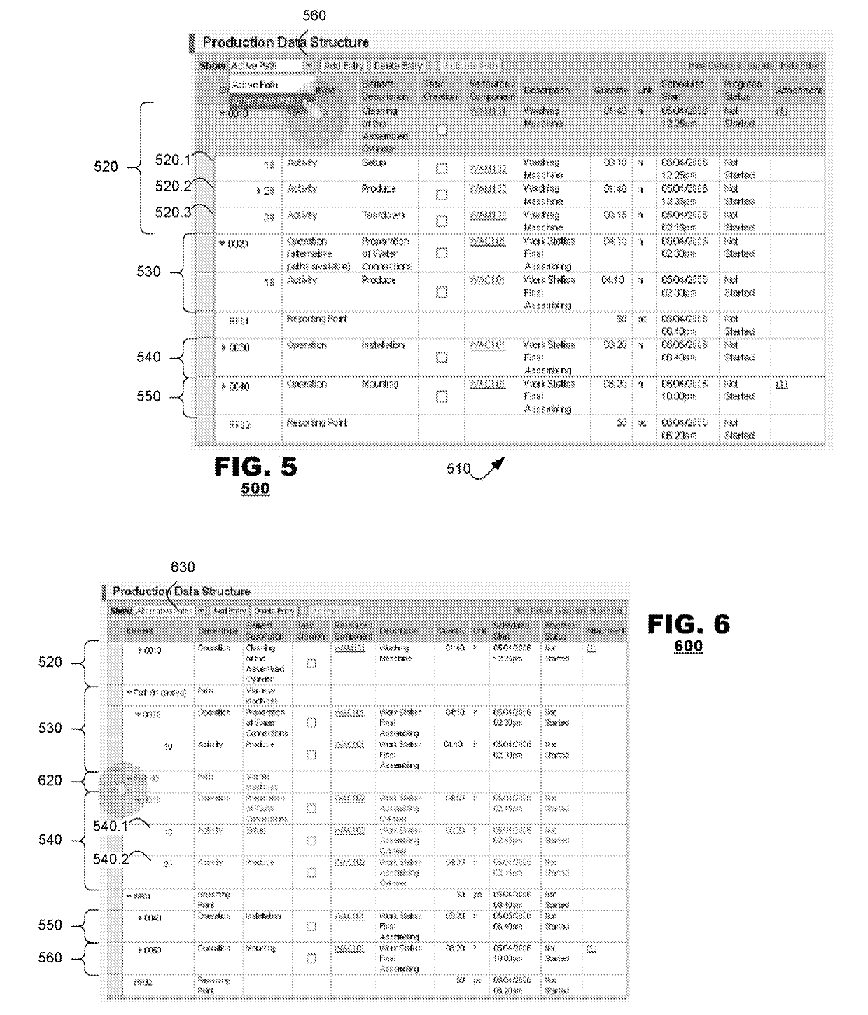

FIG. 5 is an example of a possible user interface screen generated in Box 330. Box 340 is representative of the user interface engine receiving a selection of one of the alternative paths in the hierarchy from an end user. The user can decide not to select an alternative or to go with the default alternative; in either case no further need to dynamically generate user interface screens is required of the use interface engine. However if the end user selects an alternative path in BOX 340 the methodology is that the user interface engine then proceeds to retrieve, by way of the Application (130 of FIG. 1), substantive data for the selected alternative path from Business Object Storage (140 of FIG. 1). BOX 350 is representative of user interface engine retrieving substantive data from Business Object Storage (140 of FIG. 1) for the selected alternative path. After the data for the selected alternative has been retrieved once again the user interface engine determines how to best to construct and populate the user interface screen to include the required steps, the alternative and the related substantive data for each. BOX 360 represents the user interface rendering a new UI screen which displays substantive data of the required process steps and the selected alternative hierarchy path.

FIGS. 5 and 6 provide examples of user interface screens 500, 600 that may be generated from process objects using the foregoing method. Turning to FIG. 5, the screen may include a workspace 510 in which the object data is displayed. The workspace 510 may include an ordered array of information in which a first axis is organized according to the process steps 520-550 specified in the process object and the second axis is organized according to data fields within the process steps. Individual cells formed at the intersection of the axes may be populated with object data. The process steps 520-550 may identify sub-steps (e.g., 520.1-520.3) as may be appropriate.

In the example of FIG. 5, process step “0020” (530) may have several other alternatives defined for it (not shown). The user interface 500 may include a control 560 to permit an operator to reveal alternative process steps and select alternate steps for use. In FIG. 5, the control 560 is illustrated as a pull down menu.

FIG. 6 illustrates a user interface screen 600 corresponding to the example of FIG. 5 in which the alternative process steps are revealed. Again, the screen may include a workspace 610 in which the object data is displayed. The workspace 610 may include an ordered array of information in which a first axis is organized according to the process steps 520-560, 610 specified in the process object and the second axis is organized according to data fields within the process steps. Individual cells formed at the intersection of the axes may be populated with object data. The process steps 520-560, 610 may identify sub-steps (e.g., 540.1-540.2) as may be appropriate.

Having elected to reveal alternate process steps (labeled “alternate paths” in the figure), the user interface 600 illustrates the alternate process steps as members of the array. An operator is permitted to browse among the alternate process steps and select one for use in a given application. In the example of FIG. 6, steps 530 and 620 are illustrated as alternatives for each other. An operator may browse among them and select one. The user interface may include a control 630 to toggle between showing and revealing alternate process steps. When the operator elects to hide alternate process steps, the user interface 600 may revert back to the form shown in FIG. 5, retaining the currently selected alternate process step for display but hiding the remainder.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A method for dynamically building a user interface for an application program, comprising:
responsive to a hierarchical data object that defines process steps to be provided by the application program, classifying nodes of the master data as representing either mandatory or alternative process steps,
generating a user interface that displays the mandatory process steps and a first one of the alternative process steps and a control element,
responsive to user interaction with the control element, revising the user interface screen to replace the first alternative process step with a selected alternative process step.

2. The method of claim 1, wherein the user interface displays object data of visible process steps in an array.

3. The method of claim 2, wherein visible process steps are represented along one axis of the array.

4. The method of claim 2, wherein process steps and process sub-steps are represented along a common axis of the array.

5. A method for dynamically building a user interface for an application program, comprising:
responsive to a hierarchical data object that defines process steps to be provided by the application program, classifying nodes of the master data as representing either mandatory or alternative process steps,
generating a user interface that displays the mandatory process steps and a first one of the alternative process steps and a control element,
responsive to user interaction with the control element, revising the user interface screen to reveal other alternative process steps with the first alternative process step.

6. The method of claim 5, wherein the user interface displays object data of visible process steps in an array.

7. The method of claim 6, wherein visible process steps are represented along one axis of the array.

8. The method of claim 6, wherein process steps and process sub-steps are represented along a common axis of the array.

9. A computer system, comprising:
a plurality of backend applications, each storing business objects to support multi-step operations to be performed by the respective application;
a user interface application, responsive to objects representing hierarchical definitions of the multi-step operations that, when activated:
generates a user interface screen that represents a plurality of process steps for a selected backend application, including mandatory process steps and a first optional step
responsive to a selection of the first optional step, updates the user interface screen to display a selected alternative process step an remove the first optional process step.

10. The system of claim 9, wherein the user interface application dynamically builds a structure of the user interface screen from the hierarchical definitions.

11. The system of claim 9, wherein the user interface screen displays object data of visible process steps in an array.

12. The system of claim 11, wherein visible process steps are represented along one axis of the array.

13. The system of claim 11, wherein process steps and process sub-steps are represented along a common axis of the array.
